(19) United States
(12) Patent Application Publication
(10) Pub. No.: US 2019/0230914 A1
(43) Pub. Date: Aug. 1, 2019

(54) Fly Trap With Bait Filling System

(71) Applicants: John Raymond Williams, Waddel, AZ (US); Karen Lynn Florentin, Peoria, AZ (US)

(72) Inventors: John Raymond Williams, Waddel, AZ (US); Karen Lynn Florentin, Peoria, AZ (US)

(21) Appl. No.: 16/258,589

(22) Filed: Jan. 26, 2019

Related U.S. Application Data
(60) Provisional application No. 62/624,753, filed on Jan. 31, 2018.
(60) Provisional application No. 62/731,012, filed on Sep. 13, 2018.

(51) Int. Cl. A01M 1/10; A01M 1/02

(52) U.S. Cl. CPC A01M 1/106; A01M 1/14; A01M 1/02

(57) ABSTRACT

The embodied invention provides for the convenient addition of a liquid bait to a netting fly trap bow. The convenient addition of the bait fluid provides for enhanced operation of the fly trap, by simplifying the addition of an unpleasant material, and avoids the need for disassembly of the fly trap to provide additional bait.

### CROSS REFERENCE TO RELATED APPLICATIONS

This application claims the benefit of U.S. Provisional application No. 62/624,753 filed on Jan. 31, 2018, and U.S. Provisional application No. 62/731,012 filed on Sep. 13, 2018. The entire disclosure of both provisional applications is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

### (1) Field of the Invention

This invention is directed toward fly traps that are based on bait, that produces odors which attract flies to a netting trap.

### (2) Description of Related Art

Related ideas are found in U.S. Pat. No. 992,158, 972,873, 632,303, 1,013,320, 995,886, 1,057,867, 990,084, 1,017,644, and U.S. Pat. No. 816,499 for example. These traps do not provide for convenient addition of the bait material or fluid.

U.S. Pat. No. 1,013,320 describes a fly trap with an upper cone shaped netting and a cylindrical netting chamber underneath. Flies are drawn into the lower cylindrical chamber by bait, and remain there, due to their natural affinity to fly upward. It is difficult for a fly to find the entry to the cone due to its low position and escape the lower chamber.

Currently, the addition of bait liquid or material to a vertically oriented netting/bait fly trap is very inconvenient and unpleasant. The fly trap bowl has to be disassembled from the fly trap, and that is a difficult matter. The bait has a strong odor that is easily transferred to clothing or gloves, whether or not there is any contact with the bait, and any person who attempts to refill the bait is dissuaded from adding to the bait material. The previous art methods do not include a simplified way to re-fill the bait in the fly trap, and consequently the netting fly traps usually end up as a ‘one time’ use.

### BRIEF SUMMARY OF THE INVENTION

The embodied invention provides for the convenient addition of a liquid bait to a vertically oriented netting fly trap bowl. The convenient addition of the bait fluid provides for enhanced operation of the fly trap, by simplifying the addition of an unpleasant material, and avoids the need for disassembly of the fly trap to provide additional bait.

### BRIEF DESCRIPTION OF THE SEVERAL VIEWS OF THE DRAWING(S)

FIG. 1 shows a perspective view of the fly trap with a bait fill system.

FIG. 2 shows a perspective view of an alternate fly trap with a bait fill system.

FIG. 3 shows a perspective view of another alternate fly trap with a bait fill system.

FIGS. 4A-4C shows additional fly trap embodiments with a bait fill system.

### DETAILED DESCRIPTION OF THE INVENTION

One object of the embodied invention is to provide a vertically oriented netting fly trap with a suitable entrapment area that will capture flies between a cylindrical netting and an inner cone shaped netting. The inner cone shaped netting may be normally oriented, i.e. larger diameter at the bottom, or inverted, i.e. larger diameter at the top. Once trapped, the fly trap may be disposed of or disassembled in a way to remove the trapped insects.

Another object is to provide an affordable trap that is simple to operate and durable for the purpose it is used. Another object is to provide for continued use of the fly trap in an environment where flies are infrequent, so that the bait is useful for extended lengths of time.

With these objectives in view, the embodied invention adds an important novel feature of filling the bait bowl conveniently and efficiently as will be more particularly described and afterward specifically claimed.

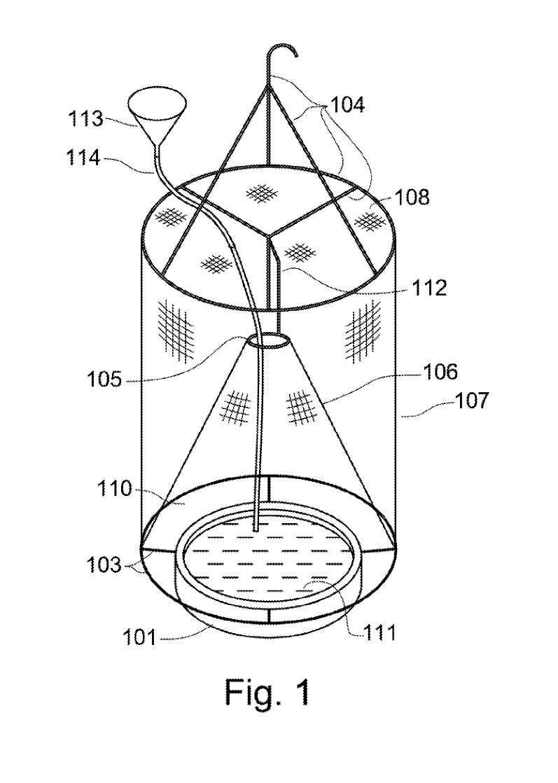

FIG. 1 shows a perspective view of a vertically oriented fly trap with the bait supply system. It is vertically oriented in the sense that the bait odor rises throughout the fly trap, and the flies are trapped when they move upwardly. A bait bowl 101 holds fly bait matter that is mounted on a bait bowl support frame 103. An upper hanging support frame 104 is used to attach the fly trap to a suitable support structure, which may be as simple as a tree branch. An inner cone netting 106 incorporates a fly trap ring 105 which allows the flies to move upwardly through it into the chamber between the inner cone netting 106 and the outer cylindrical netting 107 with an associated top flat netting 108.

A fly opening 110 around the perimeter of the bait bowl allows flies to access the odor from the bait matter in the bait bowl 101. The flies are allowed to fly upwardly onto and through the inner cone netting. They become trapped due to the nature of flies to fly upwardly. A cover 111 on top of the bait bowl prevents the flies from drowning. Optionally, the cover is removed and the flies are allowed to feed on the bait prior to flying upwardly through the inner netting 106. A support member 112 connects the fly trap ring 105 to the hanging support frame 104. A fill funnel 113 and a fill tube 114 provide for adding liquid bait to the bait bowl.

The bait in the bait bowl 101 is preferably covered 111 utilizing small slits, holes, or a wick in the cover to allow the bait odor to escape. This provides three additional benefits:
a. It keeps the liquid from evaporating quickly, thus saving on the amount of bait that is used. This allows for longer times between refilling.
b. When it rains, an uncovered bait bowl will be diluted or replaced by the rain; The semi-closed system prevents that from happening.
c. Dogs tend to be attracted to the bait and will try to drink it. The semi-closed system prevents them from doing so.
d. The covered bait bowl prevents flies from getting into the bait and drowning. If the flies drown in the bait they create a very bad odor, and cleanup is very messy.

The exact dimensions of the inner and outer nettings is not a strict requirement of the embodied invention. However, a preferred outer diameter is about 25 cm and the overall height of the netting (not including fill bowl) is about 35 cm.

The conceived invention is comprised of netting and wire, of which the wire creates the needed structural dimensions. The wire (103,104) also provides needed structural support to the netting so that moderate winds do not disrupt the operation of the trap. The wire is preferably arranged as two wire rings, where the upper wire ring is used to support and hang the trap, and the lower wire ring is used to stiffen the netting when hanging and provide bait bowl support.

It is generally conceived that the embodied invention will be used outdoors as a practical matter, due to the strong odor of the bait. However, in theory, it could be used indoors and outdoors with success.

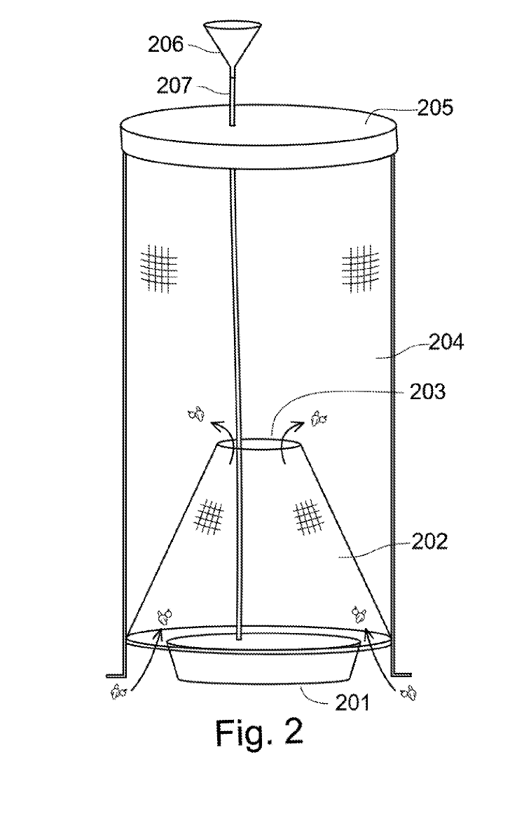

FIG. 2 shows a perspective view of an alternate fly trap with a bait fill system. In this case, the inner and outer netting are replaced by a metal screen that provides structural support for the fly trap. A bait bowl 201 with a fill funnel 206 and fill tube 207, is located under a fly trap metal screen structure. An inner metal cone screen 202 with an inner fly trap ring 203 is located inside of an outer cone metal screen 204 with a removable solid top cover 205. The cover provides access to the fly trap to empty it. Optionally, the cover 205 is made from a metal screen.

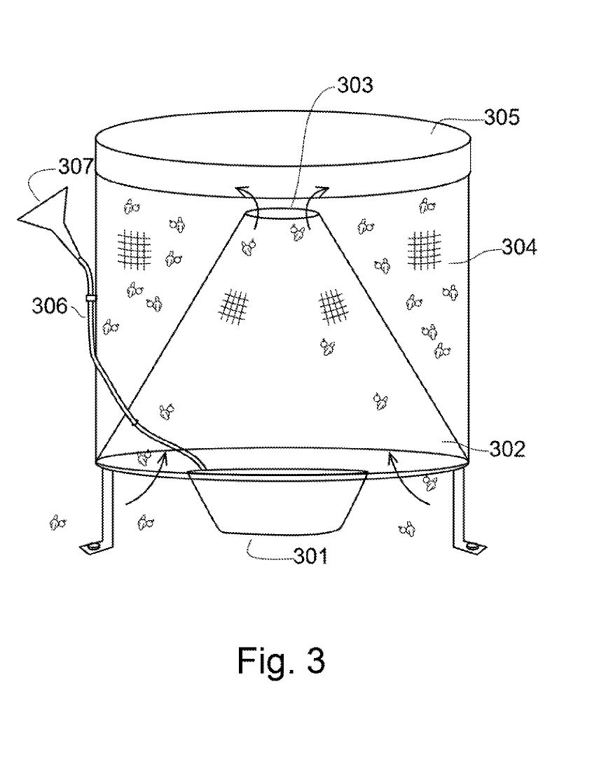

Similarly to FIG. 2, FIG. 3 shows a perspective view of another alternate fly trap with a bait fill system. The trap is smaller in size but has the same essential features as FIG. 2. A bait bowl 301, is set under the fly trap metal screens. A fill tube 306 and funnel 307 is used to replenish the bait in the bait bowl. The fill tube is attached to the side of the outer cylindrical mesh and fills the bait bowl through a tube opening in the bait bowl cover. An inner cone screen 302 with an fly trap ring 303 is located inside of an outer cone netting 304. A removable solid top cover 305 provides access to the fly trap to empty it.

The bait bowl cover and fill pipe are not confined to the disclosed traps. It will work on all net/metal screen traps that do not use the bait in an impermeable container to drown the flies.

Although a vertical rising cone is disclosed in FIGS. 1-3, other alternate traps that use an inverted cone that allows fly entry through the top cover is equally benefited by the bait bowl—cover—fill pipe system.

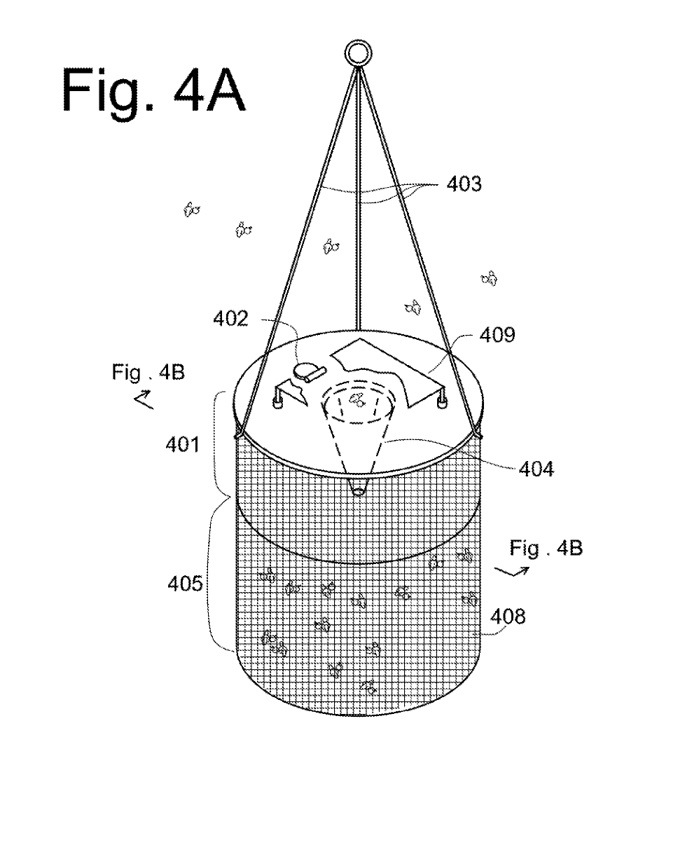

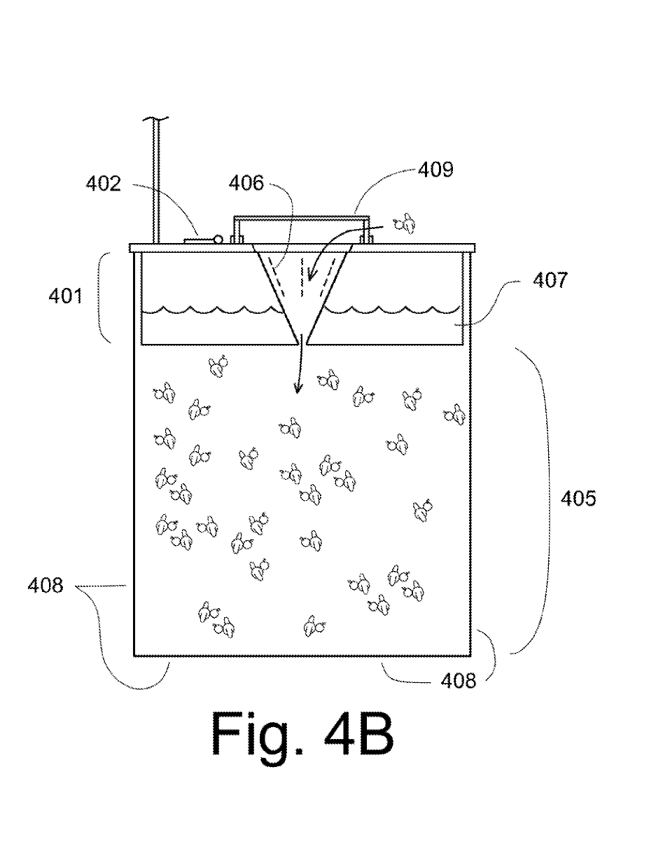

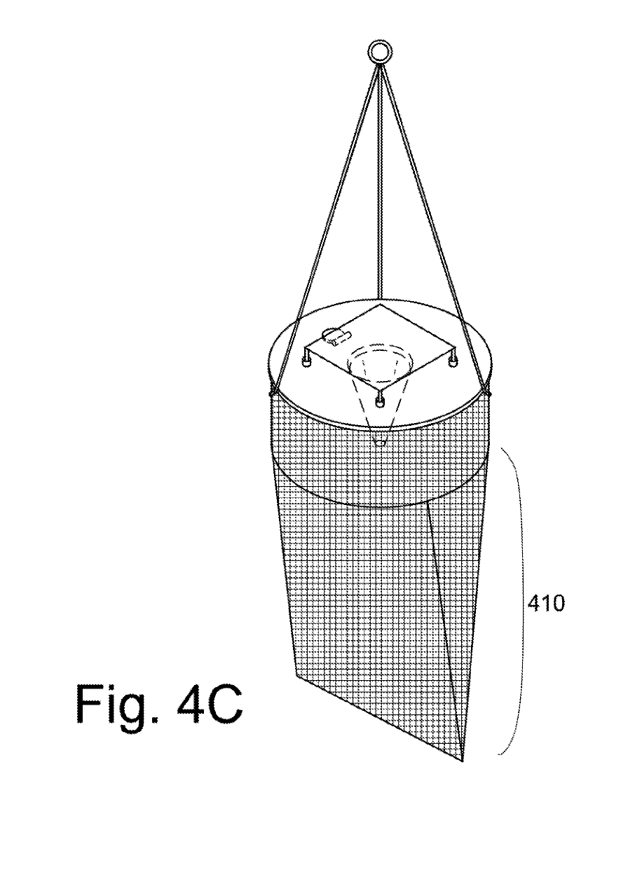

FIGS. 4A-4B is another embodied arrangement of the fly trap. FIG. 4B is a sectional view of 4A. A lower trap chamber 405 is used to trap insects by luring them in through a funnel 404 where they exit into the trap chamber and have difficulty finding the small exit hole of the funnel. An upper bait chamber 401 is used to entice the insects to the funnel by utilizing bait 407 as illustrated in FIG. 4B. A liquid bait fill hole 402 is used to fill the bait chamber with an enticing bait. The flytrap is suspended by three wires 403 or strings from a suitable support, such as a tree branch or hook. A turret or cover 409 aids in preventing the insects from escaping as the sunlight is blocked, which hinders the insects from seeking the lower funnel hole as a source of bright light.

FIG. 4B shows the upper bait chamber 401 and lower trap chamber 405 more clearly. Bait 407 is filled in the upper bait chamber through the bait fill hole 402, and the odor is allowed to escape out of the bait chamber through slots 406. The flies enter through the top end of the funnel and are trapped in the trap chamber. The lower chamber is made of netting 408 which is loosely attached to, and hangs from, the bait chamber. The netting is attached to an upper rim of the bait chamber by wires, clips, adhesion, or other suitable hardware. The netting is in a rough shape of a cylinder.

Similarly to FIGS. 4A-4B, in FIG. 4C the upper edge is round and the bottom edge a straight seam 410. Again, a turret or cover 409 is used.

The advantage of the FIG. 4A-4B arrangement is that the bait is easily replenished, and the trapped insects are not trapped in the same chamber as the bait chamber (as per some current designs). Trapped flies readily drown in liquid bait, and this adds a very strong odor to the fly trap when the flies decompose.

From the foregoing description, taken in connection with the accompanying drawings, the construction and operation of the invention will be readily understood without requiring a more extended explanation.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the This invention relates to improvements in fly traps.

I claim:

1. A refillable trap for enclosing flies comprising:
a. a bait bowl,
b. a bait bowl support frame,
c. said bait bowl being positioned within said bait bowl support frame,
d. a bait bowl cover with slots
e. said bait bowl being positioned on top of said bait bowl,
f. an inner netting chamber further comprising:
i. said inner netting chamber is cone shaped having a top opening and a bottom opening,
ii. said inner netting chamber having a vertical axis,
iii. said bottom opening connects to said bait bowl support frame,
iv. said top opening connects to a fly trap ring,
v. a fly entry space that is located between a perimeter of said bait bowl and said bait bowl support frame, and
vi. said bottom opening is larger than said top opening,
g. an outer netting chamber comprising:
i. said outer netting chamber is cylindrically shaped,
ii. a cover that is removable or fixed,
iii. said cover that is netting or solid, and
iv. said outer netting chamber is coaxial with said vertical axis,
h. a bait fill tube positioned to fill said bait bowl,
i. a fill funnel that is removably attached to said bait fill tube, and
j. a passageway through said fly entry space, said inner netting, and said fly trap ring, for the passage of insects therethrough.

2. The trap according to claim 1 wherein a hanging support is connected to said outer netting chamber.

3. The trap according to claim 2 wherein a plurality of vertical support members are connected to said bait bowl support frame, where said vertical members are positioned between said bait bowl support frame and a horizontal surface.

4. A trap for enclosing flies comprising:
a. an upper bait fill chamber shaped as a thin walled cylinder with a vertical central axis,
b. wherein said upper bait chamber further comprises:
i. an upper horizontal surface and a lower horizontal surface of said cylinder,
ii. a covered fill hole on said upper horizontal surface,
iii. a funnel shaped passageway through said upper bait chamber
iv. said funnel shaped passageway is aligned to said vertical central axis,
v. wherein said funnel shaped passageway having a larger diameter aligned to said upper horizontal surface,
vi. wherein said funnel shaped passageway has a smaller diameter aligned to said lower horizontal surface,
vii. wherein said funnel shaped passageway incorporates slots,
c. a rain cover plate positioned above said funnel shaped passageway,
d. support wires attached to said bait chamber,
e. a lower trap chamber further comprising:
i. external netting, and
ii. said external netting is attached to said upper bait chamber,

5. The trap according to claim 4 wherein a hanging support is connected to said upper bait fill chamber.
